(19) United States
(12) Patent Application Publication
(10) Pub. No.: US 2017/0009818 A1
(43) Pub. Date: Jan. 12, 2017

(54) CLUTCH ASSEMBLY

(71) Applicant: Caterpillar Inc., Peoria, IL (US)

(72) Inventors: John Bowman Salomon, Peoria, IL (US); Bryant James Whitesel, Peoria, IL (US); Jamie William Clark, Oro Valley, AZ (US)

(73) Assignee: Caterpillar Inc., Peoria, IL (US)

(21) Appl. No.: 15/274,110

(22) Filed: Sep. 23, 2016

(51) Int. Cl. F16D 25/0638; F16D 25/12; F16D 13/52

(52) U.S. Cl. CPC F16D 25/0638; F16D 13/52; F16D 25/12; F16D 2125/06

(57) ABSTRACT

A clutch assembly is provided. The clutch assembly includes a clutch housing. The clutch housing includes an inlet and an annular groove. The annular groove is in fluid communication with the inlet. The clutch assembly also includes a clutch piston adapted to reciprocate based on an application of a pressure field on the clutch piston. A piston cavity is defined by the clutch piston and the clutch housing. Also, the pressure field is applied on the clutch piston by forming a constant circumferential flow path in the piston cavity.

### TECHNICAL FIELD

The present disclosure relates to a transmission system, and more particularly to a clutch assembly associated with the transmission system.

### BACKGROUND

A transmission system associated with a machine, such as an off-highway vehicle, transmits power generated by a power source to ground engaging members of the machine. The transmission system includes a clutch assembly having a clutch housing and a clutch piston. Further, a piston cavity is defined between the clutch piston and the clutch housing. A fluid is introduced into the piston cavity to actuate the clutch piston.

Various designs of the clutch housing and the clutch piston have been proposed to facilitate a flow of the fluid into the piston cavity of the clutch assembly. However, such designs can cause canting of the clutch piston due to application of an unbalanced pressure field on the clutch piston. The canting of the clutch piston causes inconsistent piston motion, which is undesirable.

U.S. Pat. No. 4,881,628 discloses an automatic transmission which includes a first clutch including a first drum with a closed bottom portion and a first piston. The first piston is axially slidably received in the first drum to define a piston working fluid chamber in the first drum between the first piston and the closed bottom portion. The first piston having a cylindrical outer wall portion which extends away from the closed bottom portion of the first drum. The automatic transmission further includes a second clutch including a second drum coaxially received in the first drum in a manner to define between a cylindrical inner surface of the first drum and a cylindrical outer surface of the second drum a cylindrical clearance. The automatic transmission also includes a clutch plate unit including drive and driven plates which are juxtaposed. The clutch plate unit is arranged within the cylindrical clearance and compressed by a leading end of the cylindrical outer wall portion of the first piston upon application of fluid pressure to the piston working fluid chamber. The automatic transmission includes a biasing structure for biasing the first piston away from the clutch plate unit, the biasing structure being installed within the cylindrical clearance.

### SUMMARY OF THE DISCLOSURE

In one aspect of the present disclosure, a clutch assembly is provided. The clutch assembly includes a clutch housing. The clutch housing includes an inlet and an annular groove. The annular groove is in fluid communication with the inlet. The clutch assembly also includes a clutch piston adapted to reciprocate based on an application of a pressure field on the clutch piston. A piston cavity is defined by the clutch piston and the clutch housing. Also, the pressure field is applied on the clutch piston by forming a constant circumferential flow path in the piston cavity.

Other features and aspects of this disclosure will be apparent from the following description and the accompanying drawings.

### BRIEF DESCRIPTION OF THE DRAWINGS

FIG. 1 is a diagrammatic representation of an exemplary clutch assembly, according to various concepts of the present disclosure;

FIG. 2 is a partial cross-sectional view of the clutch assembly of FIG. 1, according to various concepts of the present disclosure;

FIG. 3 is a perspective view of an inlet of a piston cavity of the clutch assembly of FIG. 1, according to various concepts of the present disclosure;

FIG. 4 is a perspective view of a clutch housing of the clutch assembly of FIG. 1, according to various concepts of the present disclosure;

FIG. 5 is a perspective view of a clutch piston associated with another type of clutch assembly, according to various concepts of the present disclosure; and

FIG. 6 is a diagrammatic representation of the clutch assembly having a pressure diffuser, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

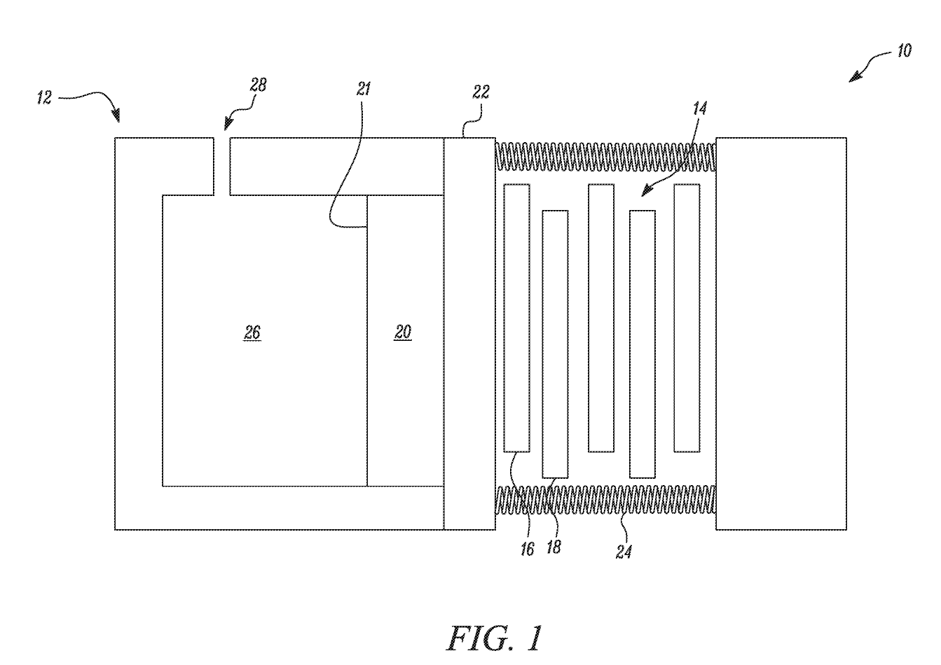

Referring to FIG. 1, an exemplary clutch assembly 10 is depicted according to one embodiment of the present disclosure. The clutch assembly 10 is located within a transmission assembly (not shown) of a machine (not shown). The machine may be associated with an industry such as, but not limited to, mining, construction, farming, earthmoving, or another industry known in the art. Further, the machine may include any one of an excavator, a shovel, a loader, a truck, etc., without limiting the scope of the present disclosure. The transmission assembly transmits torque from an engine (not shown) to a set of ground engaging members (not shown) of the machine. In the illustrated example, the transmission assembly is embodied as an automatic transmission assembly. Alternatively, the transmission assembly may be a manual transmission assembly, without limiting the scope of the disclosure.

The clutch assembly 10 includes a clutch housing 12 and a rotational member (not shown). The rotational member rotates relative to the clutch housing 12. In one example, the rotational member may embody a hub, without any limitations, based on a type of the transmission assembly. Further, the clutch assembly 10 includes a clutch pack 14. The clutch pack 14 transfers torque between the clutch housing 12 and the rotational member. The clutch pack 14 includes a number of alternating clutch plates 16 and clutch discs 18. The clutch plates 16 have external splines connected to internal splines of the clutch housing 12. Further, the clutch discs 18 have internal splines that connect to external splines of the rotational member.

The clutch assembly 10 includes a clutch piston 20 disposed within the clutch housing 12. The clutch piston 20 is adapted to reciprocate within the clutch housing 12 based on an application of a pressure field on the clutch piston 20. Based on the application of the pressure field, the clutch piston 20 applies an axial pressure on the clutch pack 14 for engaging the clutch assembly 10. In the illustrated example, the clutch piston 20 is circular in shape. The clutch assembly 10 also includes an end plate 22 provided between the clutch piston 20 and the clutch pack 14. Further, a retraction spring assembly 24 is provided between the end plate 22 and the clutch housing 12 for retracting the clutch piston 20 to its original position, when the clutch assembly 10 is disengaged. More particularly, the end plate 22 and the retraction spring assembly 24 assist in disengaging the clutch assembly 10.

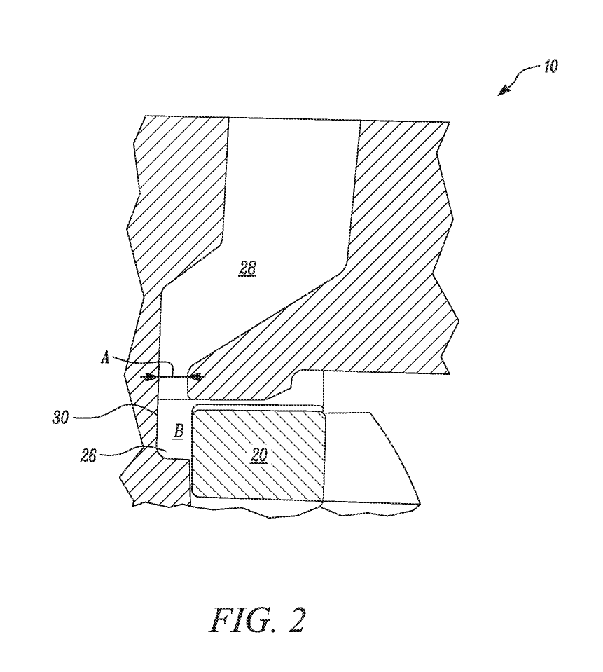

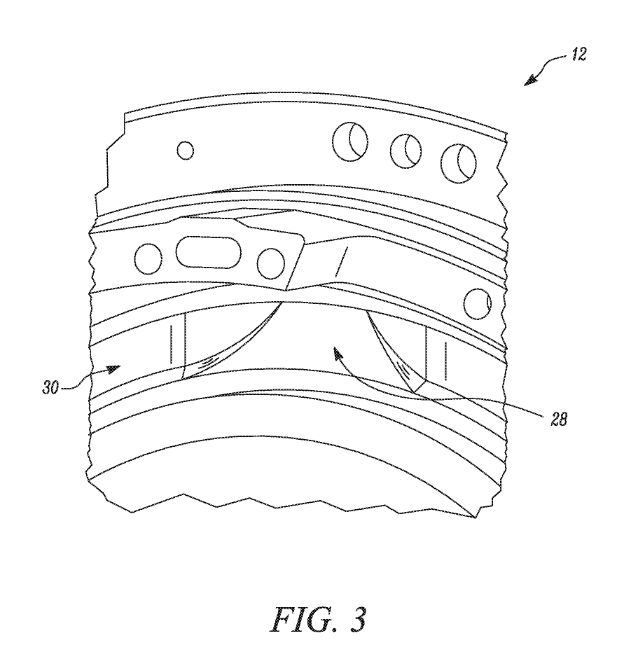

Referring to FIGS. 1 and 2, the clutch housing 12 includes an inlet 28. For actuating the clutch piston 20, a fluid is introduced in the clutch housing 12 via the inlet 28. The inlet 28 is in fluid communication with a pressurized fluid supply source (not shown). The fluid may be stored in the pressurized fluid supply source. The fluid may be a known hydraulic fluid or pneumatic fluid, that actuates the clutch piston 20, without any limitations. Further, the inlet 28 defines a first flow area “A”. The first flow area “A” receives the fluid from the pressurized fluid supply source. As shown in FIG. 3, the inlet 28 is fanned-out to reduce a velocity of the fluid entering into a piston cavity 26 (see FIG. 2). The term “fanned-out” referred to herein is indicative of a widening of the inlet 28 as it approaches the piston cavity 26.

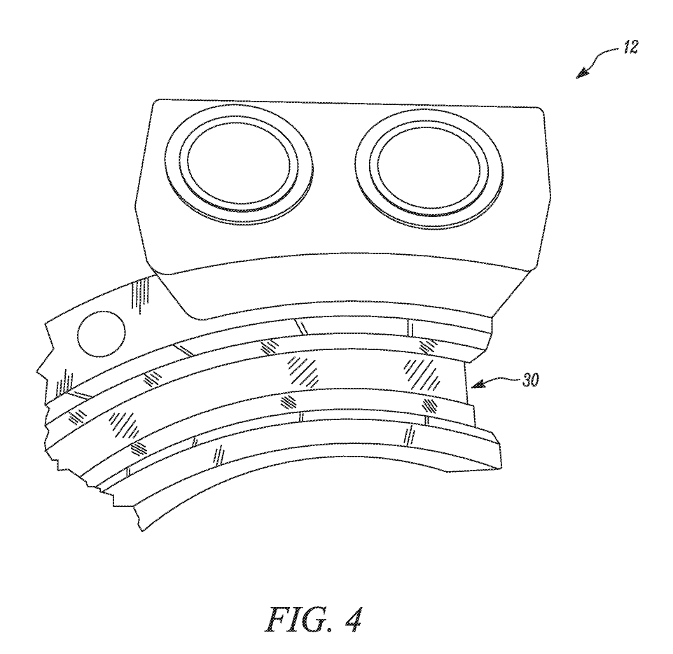

Referring to FIGS. 2 and 4, the clutch housing 12 includes an annular groove 30. The annular groove 30 is in fluid communication with the inlet 28 (see FIG. 2). Referring now to FIG. 2, the annular groove 30 and the clutch piston 20 define the piston cavity 26. The clutch piston 20 is axially movable within the piston cavity 26. The piston cavity 26 defines a second flow area “B”. The fluid is introduced in the second flow area “B” of the piston cavity 26 via the inlet 28. Thus, the second flow area “B” is in fluid communication with the first flow area “A”. The second flow area “B” includes a constant cross-sectional flow area. More particularly, the second flow area “B” of the piston cavity 26 does not change at any location throughout an annulus of the piston cavity 26. Thus, the second flow area “B” of the piston cavity 26 provides a constant circumferential flow path for the fluid flowing through the piston cavity 26.

When the clutch assembly 10 is actuated, the fluid entering the piston cavity 26 applies a balanced pressure field on the clutch piston 20 to move it axially. The movement of the clutch piston 20 causes the end plate 22 to apply an axial pressure on the clutch pack 14, thereby pressing the clutch plates 16 and the clutch discs 18. The pressing of the clutch plates 16 and the clutch discs 18 engages the clutch housing 12 with the rotational member, thereby engaging the clutch assembly 10.

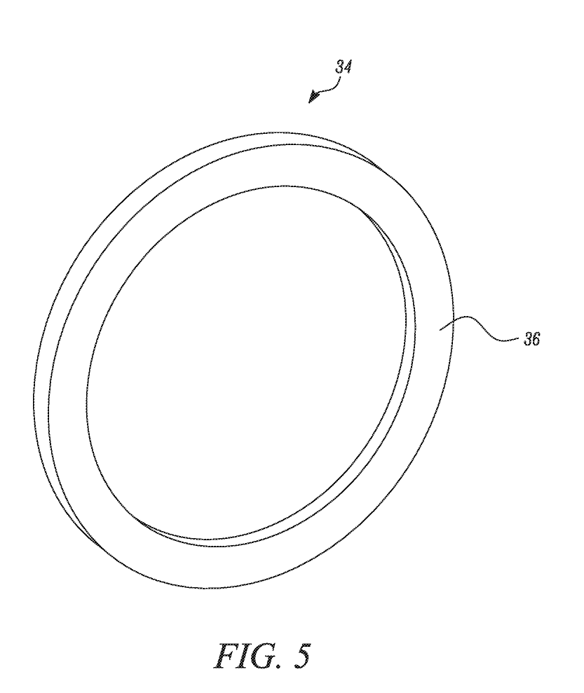

In another embodiment, as shown in FIG. 5, a clutch piston 34 of a second clutch assembly (not shown) is depicted. The second clutch assembly may include a clutch pack, a clutch housing, and a piston cavity that is defined between the clutch housing and the clutch piston 34 similar to the clutch assembly 10 explained in reference to FIGS. 1 to 4. The design of the clutch pack, the clutch housing, the inlet, and the piston cavity of the second clutch assembly may be similar to that of the clutch assembly 10. Further, the second clutch assembly may include a fanned-out inlet similar to the fanned-out inlet 28 of the clutch assembly 10.

In the illustrated embodiment, the clutch piston 34 of the second clutch assembly is circular. Further, the clutch piston 34 includes a uniform cross-sectional area. The clutch piston 34 includes a planar surface 36 which is in fluid communication with the piston cavity of the second clutch assembly. The planar surface 36 of the clutch piston 34 and the clutch housing 12 of the second clutch assembly define the constant circumferential flow path for the fluid. The constant circumferential flow path allows the fluid introduced in the piston cavity to apply the balanced pressure field on the planar surface 36 of the clutch piston 34.

In yet another example (not shown), the clutch piston 34 may include one or more moves provided on the planar surface 36. However, in such an example, the groove may include a constant cross-sectional area. More particularly, the groove is provided such that the groove does not include any projections, obstructions, or other such variations, that change the cross-sectional flow area of the groove. Thus, the groove having the constant cross-sectional area will allow the fluid introduced in the piston cavity to apply the balanced pressure field on the clutch piston 34.

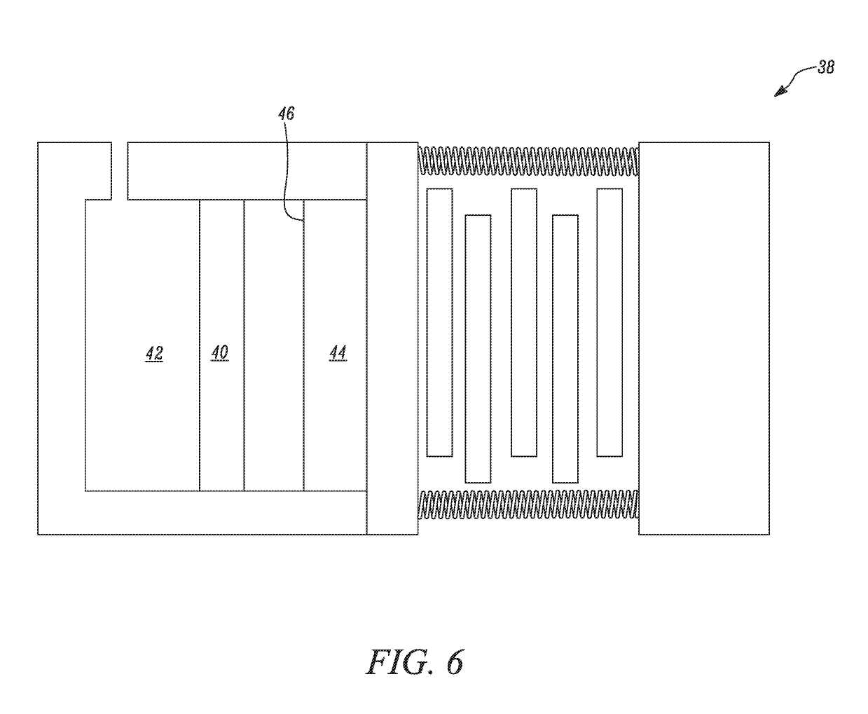

Referring to FIG. 6, a third clutch assembly 38 is depicted. The third clutch assembly 38 includes a pressure diffuser 40. The pressure diffuser 40 is disposed within a piston cavity 42 of the third clutch assembly 38. The pressure diffuser 40 isolates a clutch piston 44 from application of an unbalanced pressure field on the clutch piston 44. More particularly, the pressure diffuser 40 ensures the application of the balanced pressure field on a surface 46 of the clutch piston 44. In one example, the pressure diffuser 40 may be a circular plate. Further, the pressure diffuser 40 includes a number of through holes not shown). The number of through holes are positioned at optimized locations across the pressure diffuser 40 in order to balance the pressure field acting on the clutch piston 44. Further, the position and spacing of the number of through holes may be varied in order to compensate for a topology of the unbalanced pressure field in the piston cavity 42.

### INDUSTRIAL APPLICABILITY

The present disclosure relates to the clutch assemblies disclosed herein. The clutch assemblies are used in various transmission assemblies of stationary or mobile machines. The clutch assemblies provide a simple and ergonomic solution to avoid canting of the clutch piston of the respective clutch assemblies. The clutch assemblies provide the constant circumferential flow path for the fluid in the piston cavity due to which the balanced pressure field is applied on the respective clutch piston. The application of the balanced pressure field on the clutch piston in turn eliminates canting of the clutch piston during actuation.

In the clutch assembly 10 shown in FIGS. 1 to 4, the balanced pressure field on the clutch piston 20 is applied by providing the second flow area “B” having the constant cross-sectional area throughout the annulus of the piston cavity 42. The constant cross-sectional second flow area “B” in turn provides the constant circumferential flow path for the fluid flowing through the piston cavity 42. Since the piston cavity 42 does not include any design features that change the second flow area “B” of the piston cavity 42, problems associated with the application of the unbalanced pressure field due to changes in the flow area of the piston cavity 42 are eliminated. Further, the fanned-out inlet 28 in fluid communication with the piston cavity 26 reduces momentum exchange between the fluid and the clutch piston 20.

Further, in the second clutch assembly, the balanced pressure field is applied on the clutch piston 34 by providing the clutch piston 34 having the planar surface 36. The clutch piston 34 does not include any changes in the flow area of the piston cavity that restricts the flow of the fluid through the piston cavity and the clutch piston 34. As the piston cavity defines the constant circumferential flow path, the fluid does not experience any back pressure or flow restrictions while flowing through the piston cavity. Thus, the current design allows the balanced pressure field to be applied on the clutch piston 34.

Additionally, the third clutch assembly 38 shown in FIG. 6 includes the pressure diffuser 40 that isolates the clutch piston 44 from the unbalanced pressure field, allowing only the balanced pressure field to act on the clutch piston 44. The application of the balanced pressure field on the clutch piston 44 eliminates canting of the clutch piston 44 during actuation.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A clutch assembly comprising:
a clutch housing having an inlet and an annular groove, wherein the annular groove is in fluid communication with the inlet; and
a clutch piston adapted to reciprocate based on an application of a pressure field on the clutch piston, wherein the clutch piston and the clutch housing together define a piston cavity,
wherein the pressure field is applied on the clutch piston by forming a constant circumferential flow path in the piston cavity.

2. The clutch assembly of claim 1, wherein the clutch assembly includes a pressure diffuser for application of the pressure field on the clutch piston.
